(19) United States
(12) Patent Application Publication
(10) Pub. No.: US 2014/0045137 A1
(43) Pub. Date: Feb. 13, 2014

(54) ORTHODONTIC ARCHWIRE BRACKET

(71) Applicants: José Enrique SOLANO REINA, Sevilla (ES); Asunción MENDOZA MENDOZA, Sevilla (ES)

(72) Inventors: José Enrique SOLANO REINA, Sevilla (ES); Asunción MENDOZA MENDOZA, Sevilla (ES)

(21) Appl. No.: 14/053,541

(22) Filed: Oct. 14, 2013

Related U.S. Application Data
(63) Continuation-in-part of application No. 13/304,519, filed on Nov. 25, 2011, now abandoned.

(30) Foreign Application Priority Data
Nov. 25, 2010 (EP) 10380142.9

(51) Int. Cl. A61C 7/30

(52) U.S. Cl. CPC A61C 7/30
USPC 433/9

(57) ABSTRACT

An orthodontic archwire bracket having a first body (10) with a base (11) configured to be fixed to a tooth and a second body (20) with a central hollow portion (25) and a slot (21) formed by two slot portions (21a, 21b) on opposite sides of the central hollow portion (25). The slot (21) is configured to receive an archwire. A ball joint coupling connects the first and second bodies (10, 20). The second body (20) is made at least in part of a material with shape memory that maintains an original shape at body temperature thus locking the ball joint coupling, and acquires a deformable state at a temperature below body temperature. In one embodiment, the second body (20) further has retaining members (26) extending into each of the slot portions (21a, 21b) next to an inlet thereof.

### TECHNICAL FIELD

The present invention relates to an archwire bracket applicable to orthodontic techniques which use an archwire secured to a plurality of such brackets, which are in turn fixed to several teeth of a patient, to apply a predetermined torque to said teeth and thus correct defects in the teeth. This archwire bracket is also often referred to with the term “bracket” in the orthodontics sector.

### BACKGROUND OF THE INVENTION

Patent ES-A-2232243, of the same inventor as the present invention, describes an orthodontic archwire bracket including a first body with a base for being fixed to a tooth, a second body with a slot for the archwire, and an adjustment mechanism based on a cylindrical joint coupling between said first and second bodies. The second body is made of a material with shape memory due to a thermal effect, such that when the two bodies are cooled they are capable of mutual movement, and when they are heated to body temperature the expansion of the second body locks the joint coupling in a desired position, which allows adjusting the torque and the inclination of the archwire without needing to change the bracket.

Nevertheless, a drawback of this bracket of the mentioned patent ES-A-2232243 is that the cylindrical joint coupling only allows adjustments of the angular position of the slot in one axis. Another drawback is that the second body is essentially solid, so it is economically costly due to the relatively high price of the material with shape memory and the impossibility of making it functional. Yet another drawback is that the second body does not include means for retaining the archwire in the corresponding slot, which forces resorting to additional means.

International patent application WO 03/000151 discloses an orthodontic archwire bracket comprising a base to which there is fixed a plurality of parts having respective slot portions which together define a slot for the archwire and cavities between the slot portions where there are housed C-shaped latches for retaining the archwire in the slot. The latches can optionally be made of a material with shape memory. Nevertheless, this archwire bracket does not include adjustment means for varying the angular position of the archwire with respect to the base and the torque transmitted by the latter to the bracket. Furthermore, said plurality of parts imposes onerous manufacturing and assembly tasks.

### DISCLOSURE OF THE INVENTION

The present invention contributes to mitigating the previous and other drawbacks by providing an orthodontic archwire bracket of the type comprising a first body provided with a base configured to be fixed to a tooth and a second body provided with a main slot configured to receive an archwire. A ball joint coupling connects the first and second bodies to one another. The second body or at least part of the second body is made of a material with shape memory that maintains an original shape at a first temperature equivalent to body temperature and acquires a deformable state at a second temperature below body temperature.

The first and second bodies are sized such that said ball joint coupling allows relative movements between the first and second bodies when both are at said second temperature at which the second body is deformable and the ball joint coupling is locked by friction between the first and second bodies when both are heated to said first temperature at which the second body recovers its original shape. Given that the first temperature is equivalent to body temperature, the spherical ball joint coupling is locked when the archwire bracket is installed in the mouth of a patient.

The ball joint coupling is preferably a spherical ball joint coupling, for which the present invention envisages two reverse embodiments. In a first embodiment, the spherical ball joint coupling is formed by one or more inner spherical surface portions formed in a hollow of the first body and one or more outer spherical surface portions formed in the second body, in which case the second body, or at least the region of the second body having formed therein the outer spherical surface portions, is housed inside the hollow of the first body. In a second embodiment, the spherical ball joint coupling is formed by one or more outer spherical surface portions formed in the first body and one or more inner spherical surface portions formed in said central hollow portion of the second body, in which case the region of the first body having formed therein the outer spherical surface portions is housed inside the central hollow portion of the second body.

The second body comprises a perimetral wall portion surrounding a central hollow portion. Said main slot is formed in said perimetral wall portion and comprises two mutually aligned main slot portions located on opposite sides of said central hollow portion. In the first embodiment and in a variant of the second embodiment, the whole second body is made of said material with shape memory and the second body further comprises retaining members extending into each of said main slot portions next to an inlet thereof. These retaining members are configured to retain said archwire in the main slot portions when the second body is in said original shape and to allow inserting and removing the archwire from the main slot portions by the deformation of the second body when the latter is at the second temperature below body temperature.

In another variant of the second embodiment, the second body comprises a main second body part made of a polymeric material and a ring second body partmade of the material with shape memory. Said ring second body part is fit around an outer perimetral surface of said main second body part. The main second body part comprises said perimetral wall portion surrounding a central hollow portion, and a slit cutting said perimetral wall portion to provide elasticity to the main second body part, so that the ball joint coupling allows relative movements between the first body and the main second body part of the second body when they are together with the ring second body part at said second temperature at which the ring second body part is deformable, and the ring second body part constricts the main second body part to lock the ball joint coupling by friction between the first body and the main body portion of the second body when are heated together with the ring portion to said first temperature at which the second body recovers its original shape. Retaining means, such as a movable retaining element, are provided to retain the archwire in the main slot portions.

The second body, when it is wholly made of the material with shape memory, includes hollow portions, truncations, transverse slots and notches for facilitating the deformation thereof when it is in the deformable state for the purpose of inserting the region of the first or second body having formed therein the outer spherical surface portions into the hollow of the second or first body having formed therein the inner spherical surface portions.

The mentioned hollow portions, truncations, transverse slots and notches are furthermore designed in both embodiments to assure the functionality without fractures occurring for the purpose of minimizing the manufacturing cost of the bracket, taking into account the relatively high price of the material with shape memory.

With the described configuration, the orthodontic archwire bracket of the present invention allows performing adjustments in the torque imparted by the archwire to the tooth through the bracket and in the angular position of the archwire with respect to the base of the bracket in three coordinate axes as a result of the spherical ball joint coupling and of the material with shape memory used for the second body or for the ring second body part of the second body.

Furthermore, the archwire bracket of the present invention, when the second body is wholly made of the material with shape memory, incorporates retaining means for retaining the archwire in the main slot without needing to use additional elements, which allows reducing the general volume of the bracket and limiting the total number of parts to only two parts.

### BRIEF DESCRIPTION OF THE DRAWINGS

The previous and other features and advantages will be more fully understood from the following detailed description of several exemplary embodiments with reference to the attached drawings, in which:

FIG. 1 is a perspective view of separated first body and second body which once mutually coupled form an orthodontic archwire bracket according to a first embodiment of the present invention;

FIG. 2 is a perspective view of the bracket according to the first embodiment formed by the mutually coupled first and second bodies, and a portion of the archwire separated from the bracket;

FIG. 3 is a perspective view of the bracket according to the first embodiment with the portion of the archwire coupled thereto;

FIG. 4 is a cross-sectional view of the bracket according to the first embodiment with the portion of the archwire coupled thereto taken through a middle plane perpendicular to the longitudinal axis of the archwire;

FIG. 5 is a cross-sectional view of the bracket according to the first embodiment with the portion of the archwire coupled thereto taken through a middle plane parallel to the longitudinal axis of the archwire;

FIG. 6 is a perspective view of separated first body and second body which once mutually coupled form an orthodontic archwire bracket according to a first variant of a second embodiment of the present invention;

FIG. 7 is a perspective view of the bracket according to the first variant of the second embodiment, which is formed by the mutually coupled first and second bodies, and a portion of the archwire separated from the bracket;

FIG. 8 is a perspective view of the bracket according to the first variant of the second embodiment with the portion of the archwire coupled thereto;

FIG. 9 is a side elevational view of the bracket according to the first variant of the second embodiment with the portion of the archwire coupled thereto seen in a direction parallel to the longitudinal axis of the archwire;

FIG. 10 is a side elevational view of the bracket according to the first variant of the second embodiment with the portion of the archwire coupled thereto seen in a direction perpendicular to the longitudinal axis of the archwire;

FIG. 11 is an exploded perspective view of a first body, a main second body part and a ring second body part forming a second body, and a retaining element which once mutually coupled form an orthodontic archwire bracket according to a second variant of the second embodiment of the present invention;

FIG. 12 is a perspective view of the bracket according to the second variant of the second embodiment assembled, with the retaining element in an open position, and with a portion of the archwire about to be inserted into the bracket;

FIG. 13 is a perspective view of the bracket according to the second variant of the second embodiment assembled, with the retaining element in a closed position retaining a portion of the archwire in the bracket;

FIG. 14 is a plan view of the bracket according to the second variant of the second embodiment assembled, with the retaining element in the closed position;

FIG. 15 is a cross-sectional view taken along the section line XV-XV of FIG. 14; and

FIG. 16 is a cross-sectional view similar to FIG. 15 with the retaining element in an open position.

### DETAILED DESCRIPTION OF EXEMPLARY EMBODIMENTS

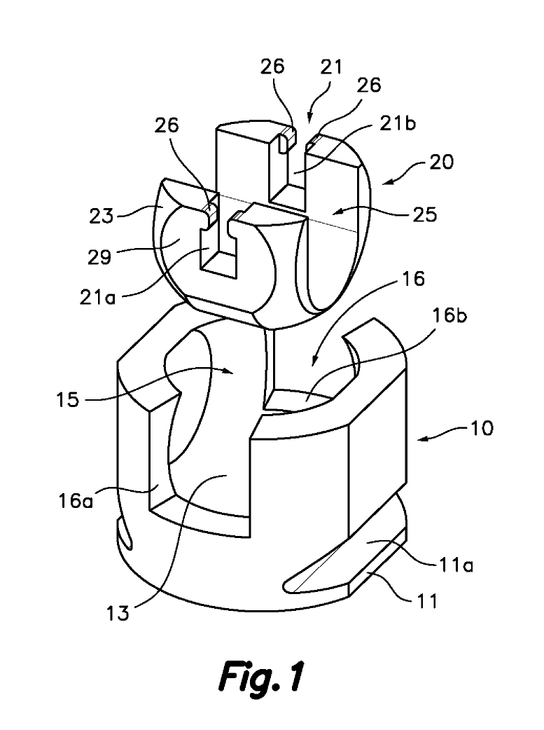

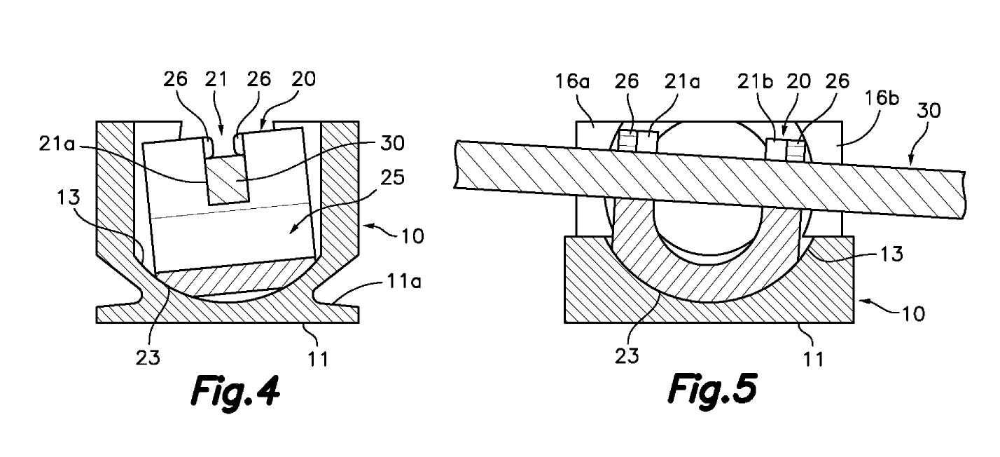

With reference first to FIGS. 1 to 5, a first embodiment of the orthodontic archwire bracket according to the present invention is described. The bracket comprises a first body 10 provided with a base 11 configured to be fixed to a tooth and a second body 20 provided with a main slot 21 configured to receive an archwire 30. In this embodiment, the first body 10 includes side slots 11a that contribute to defining the base 11.

The first body 10 has a hollow 15 in which there are formed several concentric inner spherical surface portions 13, whereas the second body 20 has formed thereon several concentric outer spherical surface portions 23 the radius of which is selected according to the radius of the inner spherical surface portions 13 of the first body to form a spherical ball joint coupling between the first body 10 and the second body 20. Alternatively, the first body 10 could have a single inner spherical surface portion 13 and the second body 20 could have a single outer spherical surface portion 23 with an equivalent result.

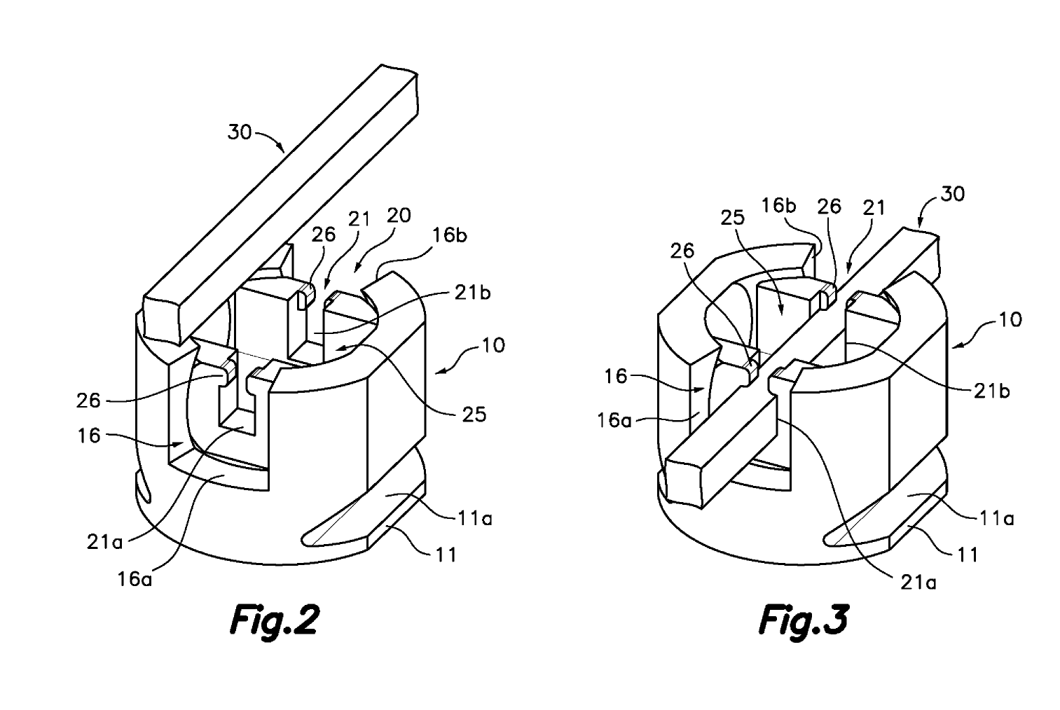

FIGS. 2 to 5 show the mutually coupled first and second bodies 10, 20, with the second body 20 housed inside said hollow 15 of the first body 1 such that the respective inner and outer spherical surface portions form the spherical ball joint coupling between both. Due to the fact that the inner spherical surface portions 13 of the first body 10 cover more than half a sphere, the second body 20 is retained such that it cannot come out of the hollow 15 of the first body 10. In the embodiment shown, the second body 20 does not protrude from the hollow 15 of the first body 10, although there is no limitation for the second body 20 to be housed only partly in the hollow 15 of the first body 10.

The second body 20 has a central hollow portion 25 and the mentioned main slot 21 is formed by two mutually aligned main slot portions 21a, 21b formed on opposite sides of said central hollow portion 25. These main slot portions 21a, 21b are configured to fit to outer surfaces of the archwire 30. The archwire bracket includes retaining means to retain the archwire 30 in the main slot 21. To that end, the second body 20 further comprises, next to a radial inlet of each of the main slot portions 21a, 21b, a pair of retaining members 26 extending towards one another and into the corresponding main slot portion 21a, 21b.

These retaining members 26 are configured to retain said archwire 30 in the main slot 21 and have rounded ends to allow the archwire 30 to be inserted and removed from the main slot portions 21a, 21b by the deformation of the second body 20, and the main slot portions 21a, 21b are configured to fit to outer surfaces of the archwire 30. Alternatively, the retaining members 26 of this first embodiment can have at their ends inclined surfaces similar to the outer and inner inclined surfaces 26a, 26b described below in relation to the second embodiment.

Thus, the archwire 30 can be introduced into the main slot 21 by pressing from outside against the retaining members 26, and is retained in the main slot 21 by the retaining members 26 without the possibility of performing movements in any radial direction with respect to its own axis. The archwire 30 can also be removed from the main slot 21 by pressing from inside against the retaining members 26.

The first body 10 also comprises a secondary slot 16 formed by two mutually aligned secondary slot portions 16a, 16b formed on opposite sides of the hollow 15 and approximately aligned with the main slot portions 21a, 21b of the second body 20 to receive the archwire 30. These secondary slot portions 16a, 16b of the first body 10 are larger than the main slot portions 21a, 21b of the second body 20 to allow the second body 20 together with the archwire 30 retained in the main slot 21 thereof to be able to perform, to a desired degree, movements with respect to the first body 10 according to three coordinate axes as a result of the spherical ball joint coupling provided by the respective inner and outer spherical surface portions 13, 23.

To immobilize the second body 20 with respect to the first body 10 in a desired position, the second body 20 is made of a material with shape memory due to a thermal effect, such as a nickel-titanium alloy, such that at a first temperature, such as body temperature, the second body 20 has an original shape and when the second body 20 is cooled to a second temperature below the first temperature it acquires a deformable state. In the mentioned original shape, the outer spherical surface portions 23 of the second body 20 have a radius slightly greater than the radius of the inner spherical surface portions 13 of the first body 10.

Thus, when the second body 20 is cooled, it becomes deformable enough to allow housing the second body 20 inside the first body 10 and when the mutually coupled first and second bodies 10, 20 are heated to body temperature, for example, due to having been installed in the mouth of a patient, the second body 20 recovers the original shape and the spherical ball joint coupling is locked in the desired position by friction between the inner and outer spherical surface portions 13, 23 of the first and second bodies 10, 20, and the archwire 30 is retained in the main slot 21 of the second body 20. At the second temperature below body temperature the archwire 30 is inserted in the main slot 21 by the deformation of the second body 20.

For the purpose of maximally reducing the risk of the second body 20 breaking when it is confined in the first body 10, a uniform section of material and smooth fitting radii have been envisaged. For the purpose of maximally reducing the economic cost of the second body, taking into account the relatively high price of the material with shape memory, the amount thereof necessary for forming the second body 20 has been minimized by means of the central hollow portion 25 and truncations 29 in the outer spherical surface portions 23.

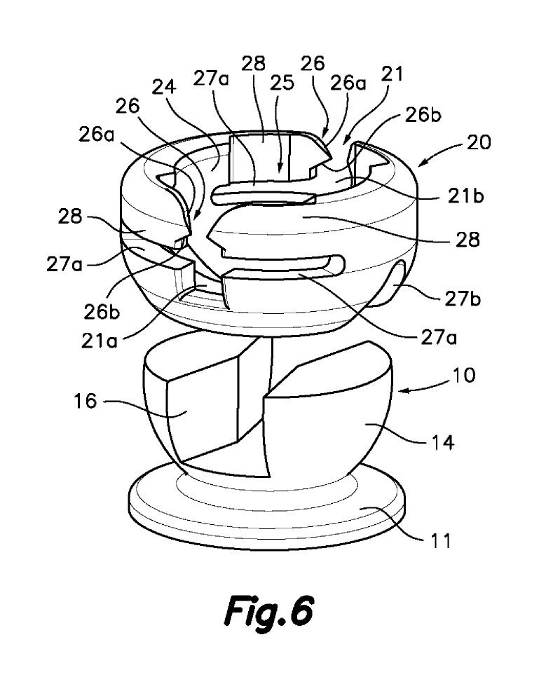

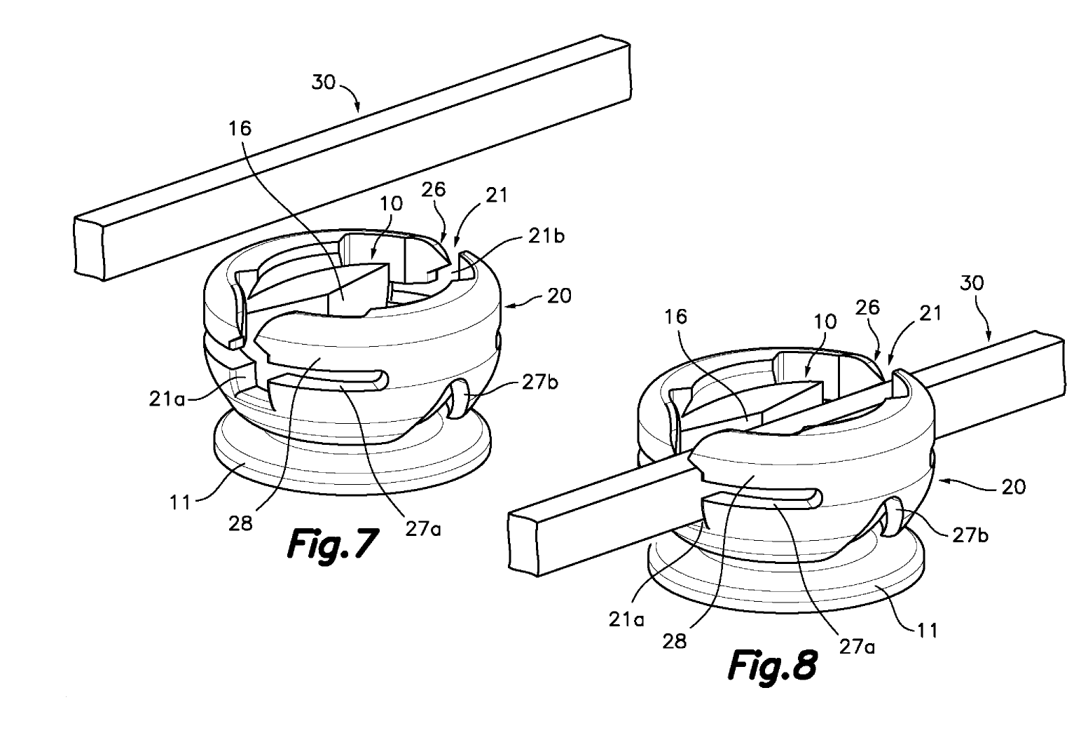

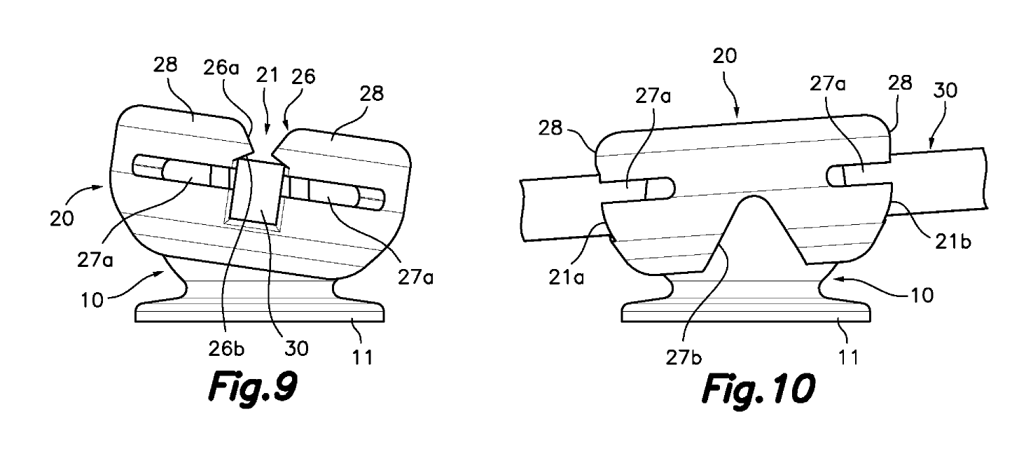

In relation now to FIGS. 6 to 10, a first variant of a second embodiment of the orthodontic archwire bracket according to the present invention is described which, like the first embodiment, comprises a first body 10 provided with a base 11 configured to be fixed to a tooth and a second body 20 provided with a main slot 21 configured to receive an archwire 30 and retaining means to retain the archwire 30 in the main slot 21, said first and second bodies 10, 20 being connected to one another by a ball joint coupling.

The essential difference lies in that, in this first variant of the second embodiment, the first body 10 has formed thereon outer spherical surface portions 14 and the second body 20 comprises a central hollow portion 25 in which there are formed inner spherical surface portions 24, and the part of the first body 10 in which said outer spherical surface portions 14 are formed is housed inside the central hollow portion 25 of the second body 20 to form the spherical ball joint coupling.

In a manner similar to the first embodiment, the main slot 21 of the second body 20 of the first variant of the second embodiment is formed by two mutually aligned main slot portions 21a, 21b formed on opposite sides of said central hollow portion 25, and these main slot portions 21a, 21b are configured to fit to outer surfaces of the archwire 30. The second body 20 further comprises, next to a radial inlet of each of the main slot portions 21a, 21b, a pair of retaining members 26 extending towards one another and into the corresponding main slot portion 21a, 21b.

Here, the retaining members 26 comprise outer inclined surfaces 26a for facilitating the insertion of the archwire 30 under pressure and inner inclined surfaces 26b for facilitating the removal of the archwire 30 under pressure. The second body 20 further comprises transverse slots 27a connected with the main slot 2 land extending therefrom to define arms 28 at the ends of which there are the retaining members 26 for facilitating the deformation of the second body 20 enough to allow the insertion and removal of the archwire 30 under pressure.

The first body 10 also comprises a secondary slot 16 for housing the archwire 30, although this secondary slot 16 of the first body 10 is larger than the main slot portions 21a, 21b of the main slot 21 of the second body 20 in a degree sufficient to allow movements of the second body 20 together with the archwire 30 retained in the main slot 21 thereof with respect to the first body. More specifically, in this first variant of the second embodiment the secondary slot 16 of the first body 10 comprises two opposite portions, which widen progressively from a central region to a peripheral region.

The second body 20 of the first variant of the second embodiment is made of a material with shape memory due to a thermal effect, such as the one described in relation to the first embodiment, although here, in the original shape, the inner spherical surface portions 24 of the second body 20 have a radius slightly smaller than the radius of the outer spherical surface portions 14 of the first body 10.

Thus, when the second body 20 is cooled it becomes deformable enough to allow housing the first body 10 inside the second body 20. When the mutually coupled first and second bodies 10, 20 are heated to body temperature, for example, due to having been installed in the mouth of a patient, the second body 20 recovers the original shape and the spherical ball joint coupling is locked to immobilize the second body 20 with respect to the first body 10 in the desired position by friction between the respective outer and inner spherical surface portions 14, 24. At the second temperature below the body temperature the archwire 30 is inserted in the main slot 21 by the deformation of the second body 20, and the archwire 30 is retained in the main slot 21 of the second body 20.

The second body 20 preferably has one or more notches 27b formed in a circumferential edge thereof adjacent to the base 11 of the first body 10, which facilitate a deformation of the second body 20 enough to allow the first body 10 to be housed in the central hollow portion 25 of the second body 20 when the second body 20 is in the deformable state.

For the purpose of maximally reducing the risk of the second body 20 breaking when it is confined in the body 10, a uniform section of material and smooth fitting radii have been envisaged. Taking into account the relatively high price of the material with shape memory, the amount thereof necessary for forming the second body 20 is minimized by the central hollow portion 25, the transverse slots 27a and said notches 27b.

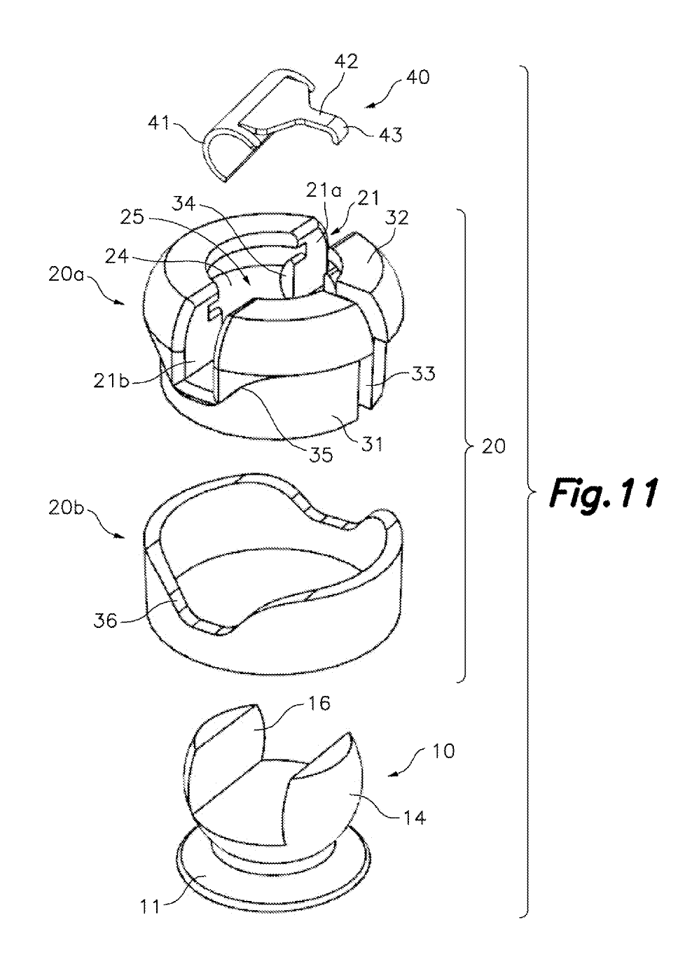

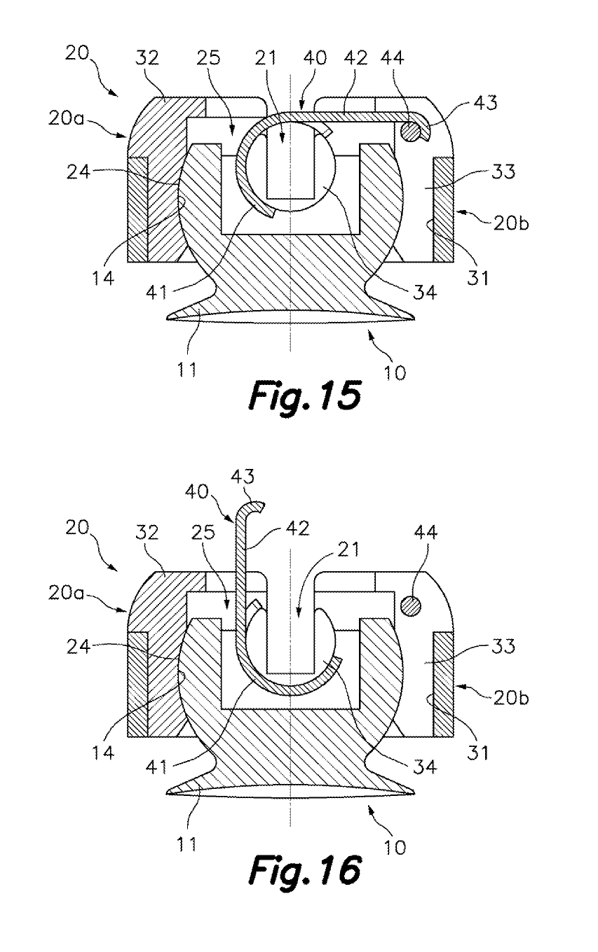

FIGS. 11 to 16 show a second variant of the second embodiment of the orthodontic archwire bracket according to the present invention, which like the first variant of the second embodiment comprises a first body 10 provided with a base 11 configured to be fixed to a tooth and a second body 20 provided with a main slot 21 configured to receive an archwire 30, as well as retaining means to retain the archwire 30 in the main slot 21, said first and second bodies 10, 20 being connected to one another by a ball joint coupling.

However, in this second variant of the second embodiment, the second body is comprised of a main second body part 20a and a ring second body part 20b coupled together. Only said ring second body part 20b of the second body 20 is made of a material with shape memory, such as a nickel-titanium alloy, while the main second body part 20a is made of a polymeric material, such as polyether ether ketone (PEEK).

The first body 10 has formed thereon outer spherical surface portions 14 and the main second body part 20a comprises a central hollow portion 25 in which there are formed inner spherical surface portions 24. The part of the first body 10 in which said outer spherical surface portions 14 are formed is housed inside the inner spherical surface portions 24 of said central hollow portion 25 of the main second body portion 20a to form the spherical ball joint coupling.

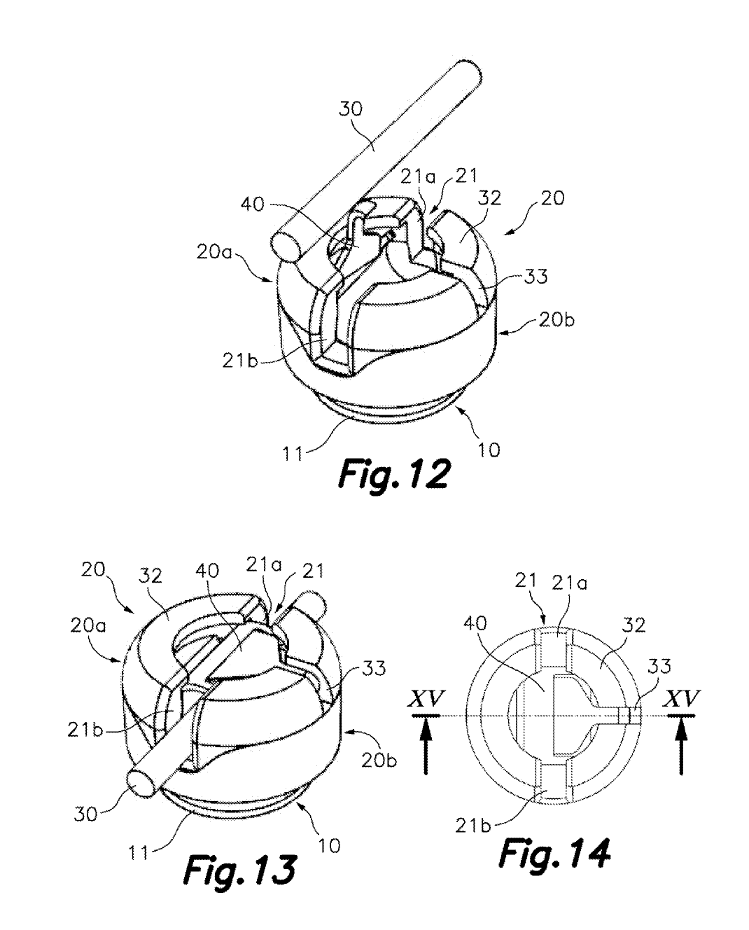

The central hollow portion 25 of the main second body part 20a is surrounded by a perimetral wall portion 32 in which a perimetral recess 31 having an outer perimetral surface is formed. When the ring second body part 20b and the main second body part 20a are assembled together to jointly form the second body 20 (FIGS. 12, 13, 15 and 16), the ring second body part 20b is fit around on said outer perimetral surface of said perimetral recess 31 of the main second body part 20a.

The perimetral wall portion 32 has formed therein at opposite sides of the central hollow portion 25 two aligned main slot portions 21a, 21b forming the main slot 21 and configured to fit to outer surfaces of the archwire 30. The first body 10 also comprises a secondary slot 16 for housing the archwire 30. This secondary slot 16 of the first body 10 is larger than the main slot portions 21a, 21b of the main slot 21 of the second body 20 in a degree sufficient to allow movements of the second body 20 together with the archwire 30 retained in the main slot 21 thereof with respect to the first body 10.

The perimetral wall portion 32 of the main second body part 20a is interrupted by a slit 33 located between the two main slot portions 21a, 21b. This slit 33 provides a gap that confers certain elasticity to the main second body part 20a. The ring second body part 20b is dimensioned so that the ball joint coupling allows relative movements between the first body 10 and the assembly of the main second body part 20a and the ring second body part 20b forming the second body 20 when they are at said second temperature at which the ring second body part is deformable.

However, when the first body 10 and the assembly of the main second body part 20a and the ring second body part 20b forming the second body 20 are heated at said first temperature at which the material with shape memory of the ring second body part 10 recovers its original shape, the ring second body part 20b constricts the main second body part 20a so that the ball joint coupling is locked by friction between the outer spherical surface portions 14 of the first body 10 and the inner spherical surface portions 24 of the main second body part 20a of the second body 20.

The aforementioned retaining means comprises a retaining element 40 which is movable between an open position (FIGS. 12 and 16), at which the retaining element 40 allows the archwire 30 to be inserted into and removed from the main slot 21, and a closed position (FIGS. 13, 14 and 15), at which the retaining element 40 retains the archwire 30 in the main slot 21. Guiding means are provided to guide the movements of the retaining element 40 between said open and closed positions.

In the example shown in FIGS. 11 to 16, the retaining element 40 is made for example of contoured sheet metal and has a concave part-cylindrical portion 41 and a retaining arm 42 ending in a bent end portion 43. In use, opposite ends of said concave part-cylindrical portion 41 of the retaining element 40 are rotationally coupled to guide lugs 34 formed in an inner surface of the perimetral wall portion 32 of the main second body part 20a and symmetrically arranged at both sides of the main slot portions 21a, 21b forming the main slot 21. In the closed position, the retaining arm 42 of the retaining element 40 is inserted in said gap provided by the slit 33 in the perimetral wall portion 32 of the main second body part 20a and said bent end portion 43 of the retaining arm 42 engages a pin 44 attached to the main second body part 20a spanning said gap.

A retaining element similar to that shown in FIGS. 11 to 16 may be alternatively used as the retaining means with a second body wholly made of the material with shape memory, such as for example the second body of the first variant of the second embodiment described in relation to FIGS. 6 to 10, instead of the integral retaining members.

Optionally, in any of the embodiments, the central hollow can be covered by means of a lid (not shown) provided as an additional part secured to the first or second body by elastic means.

A person skilled in the art will be able to think of modifications, variations and combinations from the embodiments shown and described without departing from the scope of the present invention as it is defined in the attached claims.

What is claimed is:

1. An orthodontic archwire bracket, comprising a first body provided with a base configured to be fixed to a tooth and a second body provided with a main slot configured to receive an archwire, retaining means being provided to retain said archwire in said main slot, wherein;
the first and second bodies are connected to one another by a ball joint coupling;
the second body is made of a material with shape memory which maintains an original shape at a first temperature equivalent to body temperature and acquires a deformable state at a second temperature below body temperature;
the first and second bodies are sized such that said ball joint coupling is locked by friction between the first and second bodies when both are heated to said first temperature;
the second body includes a central hollow portion and said main slot comprises two main slot portions mutually aligned on opposite sides of said central hollow portion;
said retaining means comprise retaining members formed in the second body, said retaining members extending into each of said main slot portions next to an inlet thereof
the second body further comprises transverse slots connected with the main slot and extending therefrom to define arms at the ends of which there are said retaining members, said transverse slots facilitating deformation of the second body when the latter is in said deformable state; and
the ball joint coupling is a spherical ball joint coupling comprising at least one outer spherical surface portion formed on the first body and at least one inner spherical surface portion formed in said central hollow portion of the second body, and a part of the first body on which said outer spherical surface portion is formed is housed inside the central hollow portion of the second body.

2. The archwire bracket according to claim 1, wherein said retaining members are configured to retain said archwire in the main slot portions when the second body is in said original shape and to allow inserting and removing the archwire from the main slot portions by the deformation of the second body when the latter is at said second temperature below body temperature.

3. The archwire bracket according to claim 1, wherein the second body comprises one or more notches in a circumferential edge thereof, said notches facilitating the deformation of the second body when the latter is at the second temperature below body temperature.

4. The archwire bracket according to claim 1, wherein the first body comprises a secondary slot for receiving the archwire, said secondary slot of the first body being sized to allow movements of the second body together with the archwire housed in the main slot thereof with respect to the first body when the second body is at the second temperature below body temperature.

5. The archwire bracket according to claim 1, wherein the retaining members comprise outer inclined surfaces for facilitating insertion of the archwire under pressure and inner inclined surfaces for facilitating removal of the archwire under pressure when the second body is below body temperature.

6. The archwire bracket according to claim 2, wherein the retaining members comprise outer inclined surfaces for facilitating insertion of the archwire under pressure and inner inclined surfaces for facilitating removal of the archwire under pressure when the second body is below body temperature.

7. An orthodontic archwire bracket, comprising a first body provided with a base configured to be fixed to a tooth and a second body provided with a main slot configured to receive an archwire, retaining means being provided to retain said archwire in said main slot, wherein;
the first and second bodies are connected to one another by a ball joint coupling;
the second body includes a central hollow portion and said main slot comprises two main slot portions mutually aligned on opposite sides of said central hollow portion;
the ball joint coupling is a spherical ball joint coupling comprising at least one outer spherical surface portion formed on the first body and at least one inner spherical surface portion formed in said central hollow portion of the second body, and a part of the first body on which said outer spherical surface portion is formed is housed inside the central hollow portion of the second body;
at least part of the second body is made of a material with shape memory which maintains an original shape at a first temperature equivalent to body temperature and acquires a deformable state at a second temperature below body temperature;
the first and second bodies are sized such that said ball joint coupling is locked by friction between the first and second bodies when both are heated to said first temperature.

8. The archwire bracket according to claim 7, wherein the second body is holly made of said material with shape memory and said retaining means comprise retaining members formed in the second body, said retaining members extending into each of said main slot portions next to an inlet thereof.

9. The archwire bracket according to claim 8, wherein the second body further comprises transverse slots connected with the main slot and extending therefrom to define arms at the ends of which there are said retaining members, said transverse slots facilitating deformation of the second body when the latter is in said deformable state.

10. The archwire bracket according to claim 8, wherein said retaining members comprise outer inclined surfaces for facilitating insertion of the archwire under pressure and inner inclined surfaces for facilitating removal of the archwire under pressure when the second body is at the second temperature below body temperature, and the retaining members retain said archwire in the main slot portions when the second body is in said original shape at the first temperature equivalent to body temperature.

11. The archwire bracket according to claim 7, wherein the second body comprises one or more notches in a circumferential edge thereof, said notches facilitating the deformation of the second body when the latter is at the second temperature below body temperature.

12. The archwire bracket according to claim 7, wherein the first body comprises a secondary slot for receiving the archwire, said secondary slot of the first body being sized to allow movements of the second body together with the archwire housed in the main slot thereof with respect to the first body when the second body is at the second temperature below body temperature.

13. The archwire bracket according to claim 7, wherein the second body is comprised of a main second body part and a ring second body part, said ring second body part being fit around on an outer perimetral surface of the main second body part, only said ring second body part being made of said material with shape memory, said main second body part having said central hollow portion with said inner spherical surface portion formed therein, the central hollow portion being surrounded by a perimetral wall portion interrupted by a slit providing a gap.

14. The archwire bracket according to claim 13, wherein said outer perimetral surface on which the ring second body part is fit around is provided on a perimetral recess formed in the perimetral wall portion of the main second body part.

15. The archwire bracket according to claim 14, wherein said perimetral recess is formed next to one end of the main second body part opposite to the main slot portions, and has a sinuous edge accommodating the main slot portions, and the ring second body part has a ring sinuous edge conforming said sinuous edge of the perimetral recess.

16. An orthodontic archwire bracket, comprising a first body provided with a base configured to be fixed to a tooth and a second body provided with a main slot configured to receive an archwire, retaining means being provided to retain said archwire in said main slot, wherein;
the first and second bodies are connected to one another by a ball joint coupling;
the second body is comprised of a main second body part and a ring second body part, said ring second body part being fit around on an outer perimetral surface of the main second body part;
the main second body part includes a central hollow portion surrounded by a perimetral wall portion interrupted by a slit providing a gap;
said main slot comprises two mutually aligned main slot portions formed in said perimetral wall portion on opposite sides of said central hollow portion;
the ball joint coupling is a spherical ball joint coupling comprising at least one outer spherical surface portion formed on the first body and at least one inner spherical surface portion formed in the central hollow portion of the main second body part, and a part of the first body on which said outer spherical surface portion is formed is housed inside the central hollow portion of the main second body part;
said ring second body part is made of a material with shape memory which maintains an original shape at a first temperature equivalent to body temperature and acquires a deformable state at a second temperature below body temperature;
the first body, the main second body part and the ring second body part are sized such that said ball joint coupling is locked by friction between the first body and the main second body part when the first and second bodies are heated to said first temperature.

17. The archwire bracket according to claim 16, wherein said outer perimetral surface on which the ring second body part is fit around is provided on a perimetral recess formed in the perimetral wall portion of the main second body part.

18. The archwire bracket according to claim 17, wherein said perimetral recess is formed next to one end of the main second body part opposite to the main slot portions, and has a sinuous edge accommodating the main slot portions, and the ring second body part has a ring sinuous edge conforming said sinuous edge of the perimetral recess.

19. The archwire bracket according to claim 16, wherein said retaining means comprise a retaining element which is movable between an open position, at which said retaining element allows the archwire to be inserted into and removed from the main slot, and a closed position, at which the retaining element retains the archwire in the main slot.

20. The archwire bracket according to claim 19, wherein the main second body part has formed therein guide lugs guiding rotational movements of the retaining element between said open and closed positions.
